(19) United States
(12) Patent Application Publication
(10) Pub. No.: US 2015/0226342 A1
(43) Pub. Date: Aug. 13, 2015

(54) DELTA RING SEAL FOR BALL VALVE SEAT

(71) Applicant: Charles Lo Cicero, Vaughan (CA)

(72) Inventor: Charles Lo Cicero, Vaughan (CA)

(21) Appl. No.: 14/265,504

(22) Filed: Apr. 30, 2014

(30) Foreign Application Priority Data
Feb. 11, 2014 (CA) 2842354

(51) Int. Cl. F16K 5/06

(52) U.S. Cl. CPC F16K 5/0689

(57) ABSTRACT

The present invention is a resilient delta ring seal for use in a seat for a ball valve. The seat has an annular opening for receiving and holding the delta ring seal therein so that an apex of the seal is pointed radially inward toward the ball valve and a base of the seal is orientated radially away from the ball valve. The seal base is wider than the apex and the apex protrudes beyond the opening and toward the valve. The seal apex is truncated to level the apex while the seal still extends beyond the opening and toward the valve.

### REFERENCE TO RELATED APPLICATION

This Application claims priority to Canadian Application number 2,842,354 filed on Feb. 11, 2014.

### BACKGROUND

Seats for ball valves are well known in the prior art. Balls and seats are composed of specific materials, the type of which depends on several factors, including the temperature and type of fluid flowing through the ball valves. For example, a fluid containing a large amount of particulate matter would require ball and seat materials that are resistant to abrasion.

It is also known to include additional sealing elements within seats to improve shut-off of the valve and to prevent leakage. Common sealing elements include resin inserts and elastomeric seals. The choice of sealing element also depends on factors such as the temperature and type of fluid.

Elastomeric seals are superior to resin inserts for a number of reasons. For example, elastomeric seals are easier to compress, thus requiring a much lower working pressure for sealing as compared to resin (i.e. less force is required to push the seat against the ball). In addition, elastomeric inserts are cheaper to manufacture. Since resin inserts resist compression, they require precise spherical profiles, geometry and ball surface finishes to effect a robust seal. This required precision leads to higher production costs.

Another advantage of elastomeric seals is their ability to form a seal, even when there is a small amount of damage to either the elastomeric seal or the ball surface (i.e. scratches or grooves causes by abrasion for example). Elastomeric materials can “fill in” the grooves and scratches whereas the performance of the more rigid resin seals decreases when there is even a small amount of damage to the resin seal or the ball surface.

A major problem with prior art elastomeric seals, however, is that they are susceptible to damage. For example, as fluid enters a partially open valve, the high pressure causes extrusion of elastomeric seals. In addition, elastomeric seals are susceptible to damage from abrasion by particulate matter that may be present in some fluids.

On the other hand, resin inserts exhibit several advantages over elastomeric seals. Resin inserts are inert with respect to many types of fluids, and therefore useful for a wide range of applications. Another advantage of resin inserts over elastomeric seals is that resins are virtually impermeable to gas, therefore the use of resin inserts reduces the risk of an explosive decompression of the valve if rapid decompression occurs.

Resin inserts are also more resistant to compression, and thus are useful in applications where metal to metal contact between a ball and a seat is undesirable. Furthermore, resin inserts resist wear and abrasion to a higher degree than elastomeric seals.

What is required is a ball valve seat with improved resistance to extrusion and abrasion, as well as superior seal performance.

### SUMMARY

In one embodiment, the present invention is a resilient delta ring seal for use in a seat for a ball valve. The seat has an annular opening for receiving and holding the delta ring seal therein so that an apex of the seal is pointed radially inward toward the valve and a base of the seal is orientated radially away from the ball valve. The seal base is wider than the apex and the apex protrudes beyond the opening and toward the valve; and the seal apex is truncated to level the apex while the seal still extends beyond the opening and toward the valve.

### BRIEF DESCRIPTION OF THE DRAWINGS

FIG. 1 is a ball valve of the prior art.

FIG. 2 is a perspective view of a seat for a ball valve.

FIG. 3 is a perspective view of the side of a seat for a ball valve.

FIG. 4 is a cross-section view through a ball valve and two seats.

FIG. 5 is an enlarged view of a cross-section through a seat shown in FIG. 4.

FIG. 6 is a perspective view of a delta ring seal.

FIG. 7 is a cross-section view of a delta ring seal through line 7-7.

FIG. 8 is an enlarged view of a cross-section of a delta ring seal shown in FIG. 7.

### DETAILED DESCRIPTION

The present invention is a delta ring seal for inserting within a seat for a ball valve.

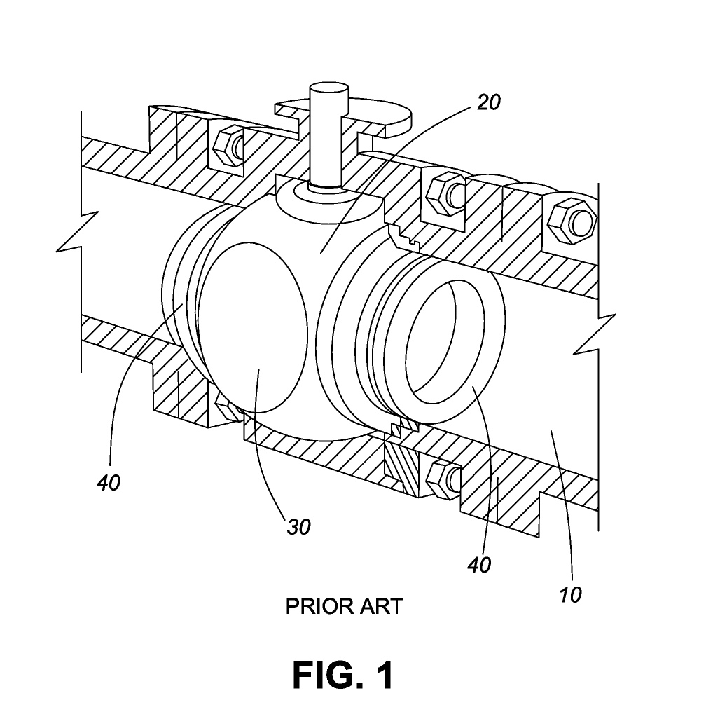

FIG. 1 shows a typical ball valve, inserted within a pipe (10). A ball (20) defining a bore (30), is positioned between two seats (40). Fluid flows through the bore (30) when the valve is turned into an open position. When the ball (20) is rotated to a closed position, the seats (40) cover the bore (30), to prevent leakage of fluid.

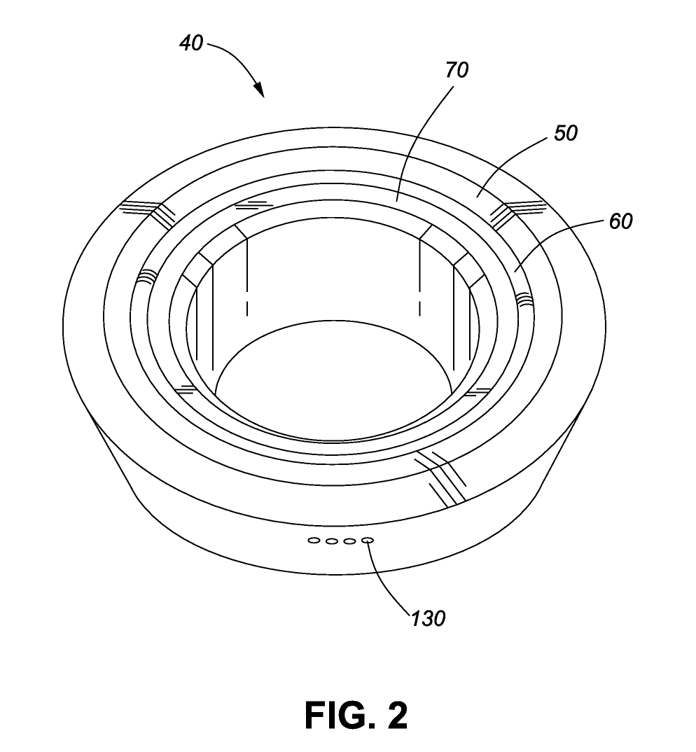

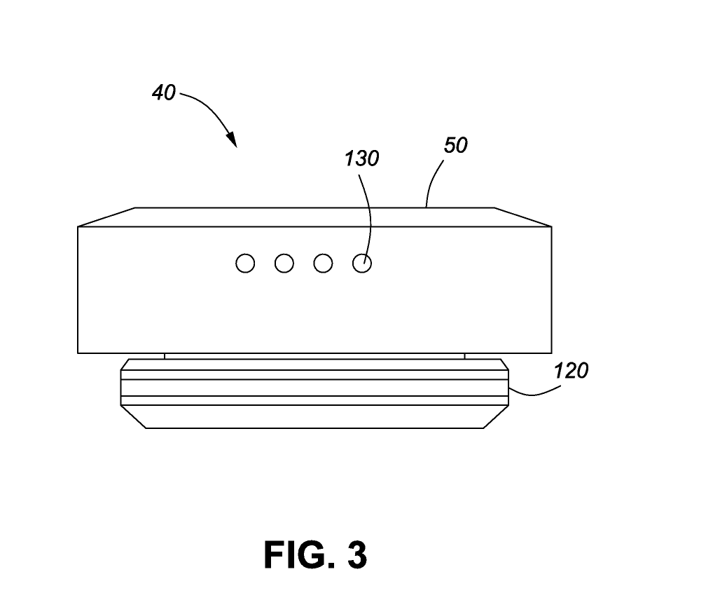

A seat (40) according to the present invention is shown in FIGS. 2 and 3. The seat (40) comprises two ends. A first end (120) is modified for attaching or inserting the ball valve (20) within a pipe (not shown).

A second end (50) of the seat (40) is adapted for sealing the ball valve (20). In the example shown in FIG. 2, two sealing elements prevent leakage of a fluid past the bore (30), namely, an elastomeric delta ring seal (60) and a resin insert (70). In the prior art normally the seal (60) and insert (70) are spaced apart from each other. This spacing apart of seal (60) and insert (70) has been discovered to also lead to seat failure and contribute to seal (60) extrusion. One such improvement in the prior art consists of placing the seal (60) adjacent the insert (70), improving the seal(60) retention strength, thereby decreasing the likelihood of seal (60) extrusion.

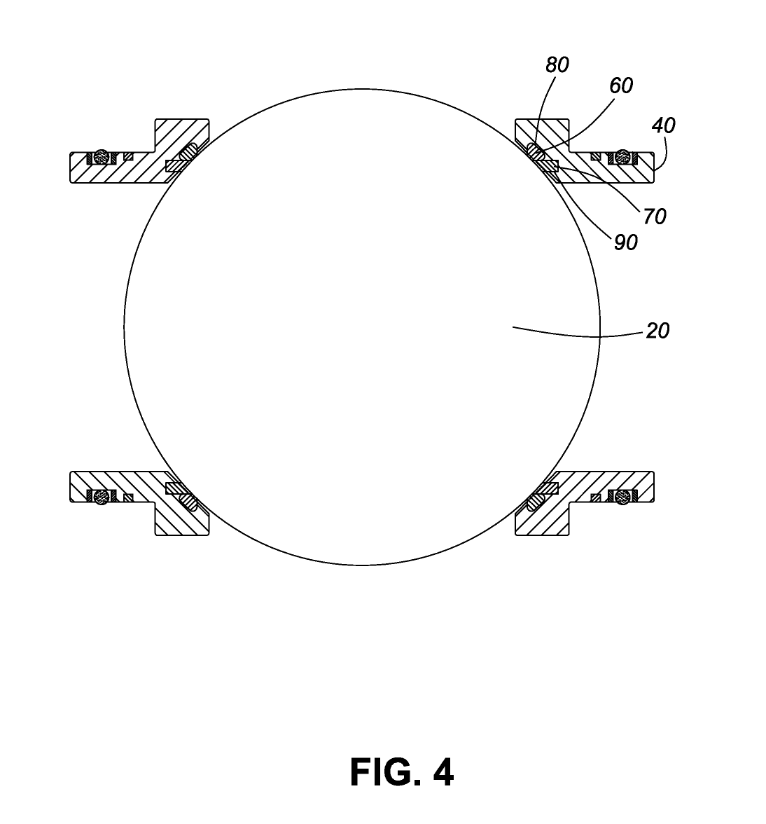

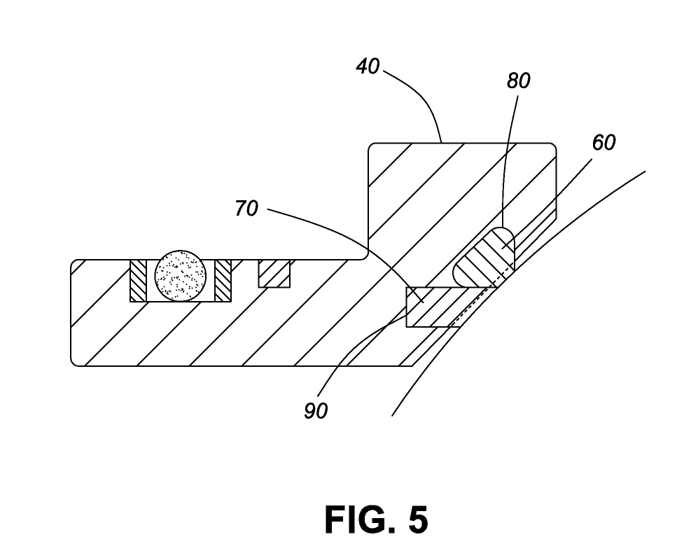

In order to accommodate the delta ring seal and insert, the contact surface (50) defines annular openings (80, 90); (as seen in cross-section in FIGS. 4 and 5), which act as housing for each of the elastomeric delta ring seal (60) and resin insert (70). The delta ring seal (60) and opening (80) are immediately adjacent the resin insert (70) and opening (90). Depending on the application, it may also be desirable to have a seat with a single annular opening for delta ring seal.

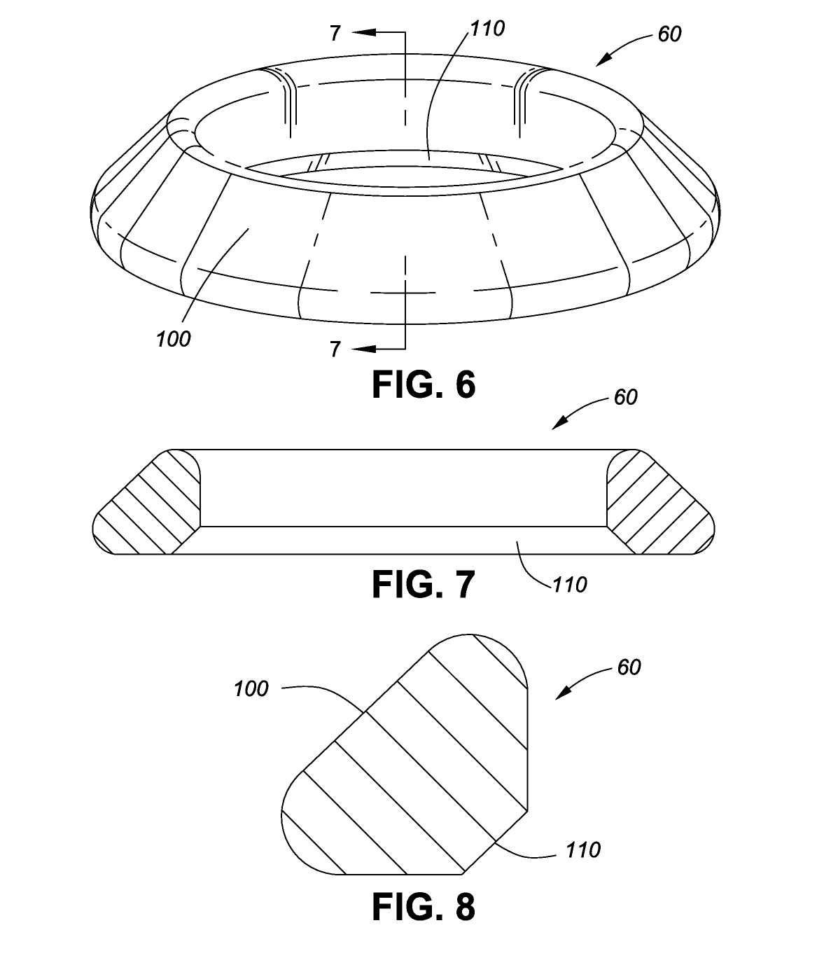

FIG. 6 shows a delta ring seal according to the present invention. The delta ring seal (60) is substantially triangular (ie as in delta from the Greek alphabet) with a trunacated apex when viewed in cross-section (see FIGS. 5 and 8). A perspective view of a section of the delta ring seal (as shown in FIG. 7), substantially has the form of a truncated pyramid.

As seen in FIG. 7, the delta ring seal has an apex (110), which points radially inward, and contacts, the ball valve (not shown); and a base (100), which is orientated radially away from the ball valve. The seal base (100) is wider than the apex (110), and the apex protrudes beyond the opening toward the valve (not shown). The seal apex (110) is truncated to level the apex while the seal still extends beyond the opening and toward the valve.

As a ball valve (20) moves through open and closed positions, fluid pressure against the delta ring seal (60) is higher when the valve (20) is only partially open. This is when seals are more likely to be damaged by extrusion. The shape of the delta ring seal (60), with its truncated apex, and relatively wider base prevents rotation and extrusion of the delta ring seal(60). The delta ring seal (60) is nestled and matingly retained within the opening (80), making seal (60) extrusion nearly impossible.

Optionally, holes/channels (80: FIGS. 2 and 3) are drilled to help dissipate the increases in fluid pressure as the ball valve (20) is rotated between open and closed positions.

When a ball (20) is rotated to a closed position, fluid will first encounter the resin insert (70), which prevents leakage toward the delta ring seal (60). The resin insert (70) is better able to withstand debris and other particulate matter that may be present within a fluid. If any fluid leaks past the resin insert (70), the delta ring seal (60) will prevent the fluid from leaking by past the ball valve.

The unit pressure between the ball (20) and the elastomeric delta-ring (60) is partially due to elastic deformation of the delta ring seal (60) when it is completely compressed in its opening within the seat (40). The pressure of any fluid that leaks into the delta ring seal (60) opening (80) compresses the delta ring seal (60) within the opening (80) and against the ball (20), thereby preventing fluid from leaking any farther into the ball valve (20). The behaviour of the elastomeric delta ring seal (60) is similar to that of a liquid in that, when subjected to a certain pressure on a certain zone (contact with the process fluid), it exerts the same pressure on the walls that are wetted by itself.

In addition, the delta ring seal (60) insert is self-energized. As the fluid pressure increases, the pressure due to contact between the delta ring seal (60) and the ball (20) rises too, exceeding in certain zones the differential pressure of the process fluid and thus creating the seal.

The optional resin insert may be composed of Nylon™, Teflon™, Devlon™, Peek™, and other resin materials known in the art.

What is claimed is:

1. A resilient delta ring seal for use in a seat for a ball valve, the seat having an annular opening for receiving and holding the delta ring seal therein so that an apex of the seal is pointed radially inward toward the valve and a base of the seal is orientated radially away from the ball valve;
wherein the seal base is wider than the apex and the apex protrudes beyond the opening and toward the valve; and
the seal apex is truncated to level the apex while the seal still extends beyond the opening and toward the valve.

2. The seal in claim 1 wherein the seal is placed in a seat apposite an annular resin insert and the seal apex is truncated to lie parallel the resin insert.

3. The seal in claim 1 wherein the delta ring seal is elastomeric. the delta ring seal is elastomeric.
